(19) United States
(12) Patent Application Publication
(10) Pub. No.: US 2026/0192299 A1
(43) Pub. Date: Jul. 9, 2026

(54) SPECIMEN CONTAINER FOR ORIENTING AND IMMOBILIZING SPECIMENS DURING IMAGING FOR REDUCED IMAGE ARTIFACTS

(71) Applicant: CLARIX IMAGING CORPORATION, Chicago, IL (US)

(72) Inventors: Nikolaj REISER, Chicago, IL (US); Xiao HAN, Chicago, IL (US)

(21) Appl. No.: 19/133,485

(22) PCT Filed: Nov. 30, 2023
(86) PCT No.: PCT/US2023/081926

§ 371 Date: May 28, 2025

Related U.S. Application Data
(60) Provisional application No. 63/429,906, filed on Dec. 2, 2022.

(51) Int. Cl. B01L 3/00

(52) U.S. Cl. CPC B01L 3/508; B01L 2200/025; B01L 2300/02; B01L 2300/04; B01L 2300/08; B01L 2300/0851; B01L 2300/0858; B01L 2300/12

(57) ABSTRACT

Improved sample container embodiments are provided for containing and supporting tissue samples during imaging. These sample containers support the samples to prevent distortion due to gravity and/or forces applied on the sample by elements of the container itself. Images generated for the samples thus more accurately reflects the geometry, composition, and orientation of the samples in the body prior to their removal. Such sample containers can include compliant cushions, which may be formed from sheets of material rather than solid volumes of foam or other materials. Such a reduction in cushion material proximate to the sample can result in improved sample imaging. The sample container can also be composed of fluid-impermeable materials to prevent absorption of fluid from the sample, reducing sample deformation and also reducing the imaging of the container material due to absorption of fluid from the sample.

### CROSS-REFERENCE TO RELATED APPLICATION

This application calls priority to U.S. provisional application No. 63/429,906, filed Dec. 2, 2022, the contents of which are hereby incorporated by reference. The contents of U.S. Pat. No. 8,605,975, filed Oct. 11, 2010, U.S. application no. 2014/0161332, filed Dec. 2, 2013, U.S. Pat. No. 9,189,871, filed Dec. 29, 2014, U.S. Pat. No. 9,613,442, filed Nov. 5, 2015, International application Do. US18/52,175, filed Sep. 21, 2018, U.S. Provisional Patent Application No. 62/562,138, filed on Sep. 22, 2017, International Application PCT/US20/62462, filed Nov. 26, 2020, International Application PCT/US21/20020, filed Feb. 26, 2021, and International Application PCT/US23/19070, filed Apr. 19, 2023, are also hereby incorporated by reference.

### BACKGROUND

The treatment for a variety of health conditions can include the removal of specified tissues from the body. For example, treatment of certain cancers can include surgically removing one or more tumor masses from the body. Other conditions can be treated by removal of other types of tissue, foreign bodies, or other masses from the body. In performing such a removal, it is desirable to ensure complete removal of the target tissue while removing as little as possible of nearby healthy tissue. In practice, surgeons will often remove additional tissue around the target in order to ensure that the target is fully removed (e.g., to prevent relapse due to remnant tumor tissue continuing to grow).

To improve patient health outcomes, the explanted tissue can be imaged to provide information to a surgeon, radiologist, pathologist, or other healthcare specialist to determine whether additional tissue should be removed (or carefully observed to provide additional information to determine whether further removal is indicated), to provide prognostic information (e.g., as to a course of post-surgical care or follow-ups to verify full removal of a cancer or other spreading disease), or to provide information for some other application.

However, the process of imaging such explanted tissues (e.g., placing them in a sample container for imaging, fixing, staining, slicing, or otherwise treating them to permit microscopic or other analyses by a pathologist) can result in significant distortion and/or deformation of the explanted tissues. This can make it difficult to correspond the imagery determined therefrom to the anatomy from which the sample was taken, to pre-surgical imagery of such anatomy, or to other information about the explanted tissue sample that could be useful in analyzing the tissue sample, deciding whether and where to remove additional tissue, or taking some other action or analysis.

### SUMMARY

An aspect of the present disclosure relates to a sample container including: (i) a rigid member that at least partially encloses a first volume; and (ii) a compliant cushion disposed within the first volume, wherein the compliant cushion comprises a sheet of material formed to at least partially enclose a portion of the first volume and to define a sample receptacle surface, wherein the sheet of material is shaped such that a sample can be placed on the sample receptacle surface and be thereby separated from the rigid member by the sheet of material.

Another aspect of the present disclosure relates to a sample container including: (i) a rigid member that at least partially encloses a first volume; (ii) a compliant cushion disposed within the first volume, wherein the compliant cushion defines a sample receptacle surface, wherein the compliant cushion is shaped such that a sample can be placed on the sample receptacle surface and be thereby separated from the rigid member by the compliant cushion; and (iii) a set of one or more labels disposed on at least one of the rigid member or the compliant cushion, wherein the set of one or more labels unambiguously indicates a default orientation for samples placed on the sample receptacle surface.

Yet another aspect of the present disclosure relates to a sample container including: (i) a rigid member that at least partially encloses a first volume; and (ii) a compliant cushion disposed within the first volume, wherein the compliant cushion defines a sample receptacle surface, wherein the compliant cushion is shaped such that a sample can be placed on the sample receptacle surface and be thereby separated from the rigid member by the compliant cushion, and wherein the sample receptacle surface of the compliant cushion is impermeable to fluid from the sample.

Yet another aspect of the present disclosure relates to a kit of two or more sample containers, wherein each sample container comprises a respective label indicative of a respective organ or tissue from an enumerated set of two or more organs or tissues.

Yet another aspect of the present disclosure relates to a method including: (i) using an imaging system to image a sample contained within a sample container to generate imaging data thereof, wherein the sample container comprises a set of one or more labels that unambiguously indicates a default orientation for samples placed within the sample container; and (ii) displaying an indication of the imaging data, wherein displaying the indication of the imaging data comprises at least one of: (a) displaying an indication of the default orientation relative to the indication of the imaging data as displayed, or (b) displaying the indication of the imaging data in an orientation that is aligned to the default orientation

Yet another aspect of the present disclosure relates to a transitory or non-transitory computer-readable medium configured to store at least computer-readable instructions that, when executed by one or more processors of a computing device, causes the computing device to perform controller operations to perform the method of the above aspect.

Yet another aspect of the present disclosure relates to a system including: (i) a controller comprising one or more processors; and (ii) a transitory or non-transitory computer-readable medium having stored therein computer-readable instructions that, when executed by the one or more processors of the controller, cause the system to perform the method of the above aspect.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE FIGURES

FIG. 1A depicts aspects of a sample container, according to example embodiments.

FIG. 1B depicts aspects of the sample container depicted in FIG. 1A, according to example embodiments.

FIG. 2A depicts a sample container and an imaging system, according to example embodiments.

FIG. 2B depicts aspects of a sample container, according to example embodiments.

FIG. 3 depicts aspects of a sample container, according to example embodiments.

FIG. 4 depicts aspects of a set of sample containers, according to example embodiments.

FIG. 5 is a simplified block diagram showing some of the components of an example system.

FIG. 6 is a flowchart of a method, according to an example embodiment.

### DETAILED DESCRIPTION

Examples of methods and systems are described herein. It should be understood that the words “exemplary,” “example,” and “illustrative,” are used herein to mean “serving as an example, instance, or illustration.” Any embodiment or feature described herein as “exemplary,” “example,” or “illustrative,” is not necessarily to be construed as preferred or advantageous over other embodiments or features. Further, the exemplary embodiments described herein are not meant to be limiting. It will be readily understood that certain aspects of the disclosed systems and methods can be arranged and combined in a wide variety of different configurations.

### I. Overview

Surgically excised tissue samples from humans and animals (or other samples of interest) are often evaluated with optical, radiological (e.g., X-ray), nuclear magnetic, or other types of imaging. When imaging such samples, it is often desirable to know the anatomical orientation of the samples, in the imaging data, relative to the anatomy from which they were excised. For example, such anatomical orientation of the imaging data can help to inform removal of additional tissue in order to completely excise cancerous or otherwise unwanted material from a body. However, such samples often lack unambiguous, recognizable anatomical landmarks. Additionally, the process of excising the samples and preparing them for imaging (e.g., by placing the samples on a stage of an imaging system, by placing the sample in a sample container that is then placed into an imaging system) can distort the tissue samples, making it even more difficult to relate the imaging data with the remaining anatomy.

Prior sample containers fail to address these needs, and exhibit a number of shortcomings:
sample orientation within the container is not labeled;
samples are not immobilized to prevent deformation or motion during the imaging process;
physical pressure may be applied to the sample and/or the sample may be deposited directly on the container bottom; as a result, pressures from the container and/or due to gravity can compress, flatten, or otherwise distort the sample on one or multiple sides, failing to preserve the original shape of the sample and leading to inaccurate evaluation of the sample based on the imaging;
liquid absorbing materials may be used to immobilize the sample that absorb liquid out of the sample, causing the sample to dry and thus lose its original constituents and shape, thereby leading to inaccurate evaluation of the sample based on the imaging;
direct contact may be made with the sample in a manner (e.g., with material of a particular composition) that leads to undesirable image artifacts or that makes it challenging to distinguish the sample from the container in the image, e.g., due to water absorbed into the support material appearing, in the imaging data, as an extension of the tissue sample; and/or
high density materials may be employed that can attenuate the incident or emitted ionizing radiation, electromagnetic waves, or other imaging energies, thereby reducing image contrast, introducing image artifacts, or otherwise degrading image quality.

Imaging-compatible sample containers and related systems and methods are provided herein that exhibit a variety of improvements relative to the prior art. Such sample containers can facilitate marking and/or tracking the orientation of a sample contained therein during imaging. Such improved sample containers can also be configured to maintain the sample's original shape and orientation while immobilizing the sample, reducing sample deformation and movement during the imaging process, thereby reducing image artifacts. Such sample containers and/or related embodiments may exhibit additional or alternative benefits, as described herein.

Sample containers as described herein may include features to facilitate the tracking of sample anatomical orientation in manner that can be easily (e.g., automatically) applied to imaging data generated of samples contained therein. For example, a sample container as described herein may include labels printed or otherwise disposed thereon/in to direct a surgeon or other person as to how to emplace a tissue sample therein. The orientation of such a sample container relative to an imaging system can then be measured and/or set such that the imaging data generated by the imaging system corresponds to the anatomical orientation of the sample (assuming that the sample was disposed in the sample container in accordance with the labeling thereof). Such containers may be provided in sets to additionally (or alternatively) facilitate the tracking of samples removed from corresponding ‘sets’ of organs, e.g., from the right and left breast, or a specified set of lymph nodes, or from some other specified set of anatomical locations.

Sample containers as described herein may be configured to immobilize samples deposited therein without significantly compressing or otherwise distorting the samples and in a manner that prevents gravity from flattening or otherwise distorting the samples. This allows the samples to be imaged in a manner that more accurately reflects the composition and geometry of the sample as it existed within the body (or other context) prior to removal and placement within the sample container. These benefits may be accomplished by using specified compliant materials to form cushions or other sample-contacting elements of the container, by forming (e.g., thermoforming) the cushions or other sample-contacting elements of the container to have shapes that correspond to the expected geometry of a sample and/or shapes that permit stabilizing forces to be exerted onto the sample without significantly distorting the sample, by using sheets of formed material to contact the sample rather than solid volumes of foam or other materials for the sample-contacting elements of the container, or by configuring the sample container in some other manner as described herein. In some examples, the cushions or other sample-contacting elements could be formed to have geometries that are organ-, tissue-, or sample-specific to facilitate imaging of samples from such specified anatomy without distorting the geometry of such samples.

Sample containers as described herein may be composed of non-absorbent materials (e.g., intrinsically non-absorbent materials, materials having a surface coating of a sealant or other substance to prevent absorption) to prevent samples from being distorted by loss of fluid and/or to prevent the material of the sample container from ‘appearing’ like the sample due to absorption of fluid from the sample. This can result in improved image quality and increased ease of distinguishing samples (and their margins) from the elements of the container in images thereof.

Sample containers as described herein may be configured to separate samples from an outer wall of the containers or otherwise distance samples from elements of the container and/or imaging apparatus that might distort energies (e.g., light, magnetic fields, RF fields, X-rays) used to image the samples, thereby improving image quality and increasing ease of distinguishing samples (and their margins) from the elements of the container in images thereof. This can be done, e.g., by forming sample-contacting cushions of the sample containers from thin sheets of material. Sample containers as described herein many also be composed of low-density materials or materials that otherwise minimally interact within imaging energies in order to reduce attenuation of incident or emitted ionizing radiation/electromagnetic waves/other imaging energies and to reduce image artifacts. For larger samples, the sample container could include extended lower walls or legs to ensure that the sample is raised above a floor, stage, or other supporting feature of an imaging apparatus in order to improve image quality (e.g., by ensuring that such a large sample is located within a “fovea” or other high-sensitivity region of an imaging volume of an imaging system).

Sample containers as described herein may be compatible with in-situ fixation or other chemical or biological manipulations of samples contained therein (e.g., by exposure to formalin). This could allow images of samples made prior to such manipulations (e.g., 3D X-ray images of a ‘fresh’ sample that has not yet been fixed) to be more directly compared with images made subsequent to such manipulations (e.g., microscopic and/or stained images of slices of a sample after the sample has been stained and/or fixed in formalin or some other fixing agent). To facilitate such in situ treatment of samples within the sample container, the sample container could be composed of materials that are resistant or immune to reaction with a treatment substance. Additionally or alternatively, the sample container could include surface treatments or coatings to prevent the treatment substance from interacting with the sample container. Such sample containers could also include lids or other elements that seal to the remainder of the sample containers in a water-tight (or other substance-tight) manner to prevent leaks.

The embodiments described herein include an example sample container that includes a rigid container with a lid, a set of low-density, non-absorbent foam “pillows” or cushions that come in contact with the sample from one or multiple directions, and a set of orientation labels or markings printed or otherwise disposed on the rigid container and/or the cushions. One example of such a sample container has a two-pillow configuration, with one pillow at the bottom of the rigid container and the other pillow attached to the underside of the lid of the rigid container. Such a configuration avoids direct contact of, and reduces proximity between, the sample with the container top and bottom. Another example of such a sample container is a configuration where one or multiple pillows completely surround the sample and separate the sample from the rigid walls of the container. Such pillows can apply a light pressure to the sample in order to immobilize it during the imaging process without causing significant deformation or distortion of the sample. Such pillows can deform to adapt to and preserve the original shape of the sample, avoiding flattened surfaces or other distortions of the sample. In addition, such pillows can prevent direct contact between the sample and the rigid container itself, reducing various imaging artifacts and/or allowing the rigid container to be composed of less optimal materials with respect to imaging, allowing the sample to be more easily distinguished from the sample container in images thereof. Additionally, pressures applied by the pillows maintains the sample approximately centered within an imaging apparatus, a position that has desirable imaging properties. Finally, the low density materials used in such an example sample container (container walls and lid, orientation labels, and pillows) reduces the attenuation of incident or emitted ionizing radiation/electromagnetic waves or other imaging energies, reducing image artifacts and improving image quality.

It should be understood that the above embodiments, and other embodiments described herein, are provided for explanatory purposes, and are not intended to be limiting.

### II. Example Embodiments of Sample Containers

As noted above, it is desirable to place samples to be imaged (e.g., explanted breast tissue that may include cancerous tissue) in sample containers that prevent the samples from being distorted (e.g., flattened by gravity against a flat bottom of the container, allowed to move due to handling of the sample/sample container) while also minimally impacting imaging of the sample (e.g., minimally attenuating X-rays or other energies used to image the sample in the sample container). It can also be beneficial for such sample containers to provide additional functionality, e.g., to facilitate determining and/or indicating the orientation of the sample prior to explantation, to facilitate calibrating an imaging system, and/or to facilitate subsequent fixation or other preparations of the sample within the sample container.

Accordingly, the embodiments described herein provide sample containers and related embodiments that provide support to samples contained therein without distorting the geometry of the samples. Such containers are composed of materials that exhibit reduced interaction with imaging energies (e.g., X-rays) and/or are configured to support a sample at a distance from elements of the container that do not exhibit such reduced interaction. Such containers may also include sample-contacting elements that are impermeable to fluids contained in the sample (e.g., that are impermeable to water, that are hydrophobic) to avoid absorption of fluid from the sample into the materials of the container. This is beneficial because it prevents the sample being distorted by loss of fluid to the container materials and it prevents the sample materials from negatively impacting sample imaging by absorption of such fluids from the sample, thereby attenuating imaging energies and/or making it more difficult to distinguish the sample from portions of the container that have absorbed fluid therefrom.

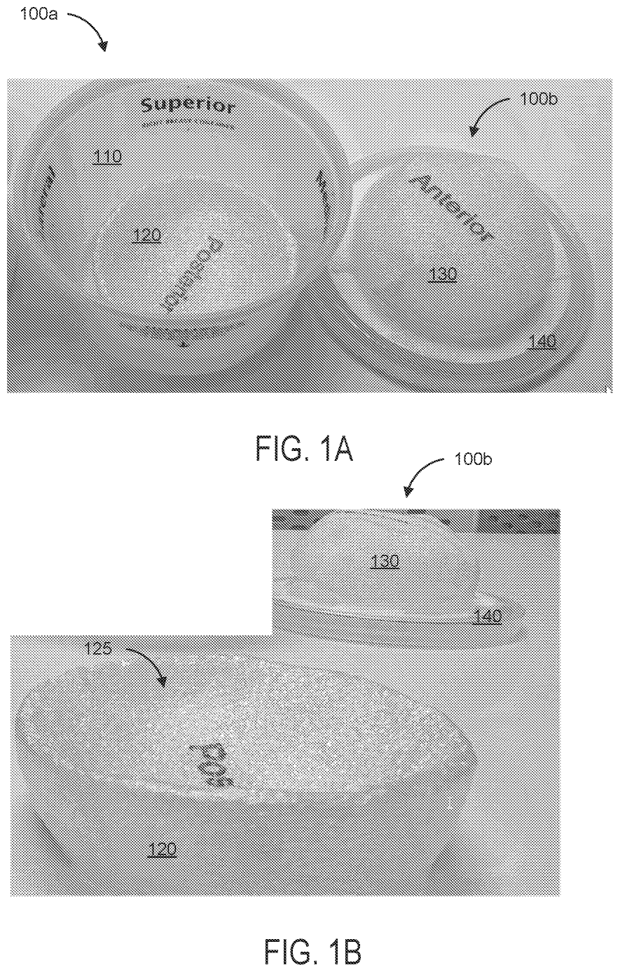

FIGS. 1A and 1B illustrate aspects of an example of such a sample container. The example sample container includes a bottom 100a and optionally a lid 100b. The bottom 100a includes a rigid member 110 that partially encloses a volume into which a sample (not shown) can be placed to be imaged. The bottom 100a also includes a compliant cushion 120 disposed within the volume enclosed by the rigid member 110 (the compliant cushion 120 has been removed from the rigid member 110 in the depiction of FIG. 1B). The compliant cushion 120 is shaped to define a sample receptacle surface 125 onto which a sample can be placed. The compliant cushion 120 is configured such that the compliant cushion 120 supports a sample disposed thereon against deformation by the force of gravity and further such that forces exerted onto the sample by the compliant cushion 120 minimally distort the sample. Thus, a sample imaged using such a sample container will more accurately represent the geometry and overall configuration of the sample prior to explantation. The compliant cushion 120 maintains a sample disposed thereon separate from the material (e.g., a floor, a curved wall) of the rigid member 110. This can reduce effects of the rigid member 110 and/or elements of an imaging system on which the rigid member 110 has been placed on imaging of the sample (e.g., due to attenuation of X-rays or other imaging energies, due to evanescent coupling or other resonant effects related to proximity between the sample and the rigid member/imaging system).

The compliant cushion of a sample container as described herein may be composed of a solid volume of compliant material (e.g., a viscoelastic foam). Alternatively, such a compliant cushion may be composed of a sheet of material (e.g., that has been thermoformed to have a specified shape, to provide a sample receptacle surface having a specified geometry, etc.). The compliant cushion 120 of FIGS. 1A and 1B is an example of such a compliant cushion, being formed from a shaped sheet of material (e.g., a thermoformed sheet of compliant foam material). The use of such a sheet of material to form one or more compliant cushions of a sample container as described herein can provide a number of benefits. Such a sheet of material can be configured to provide support to a sample while reducing the amount of distorting force that is applied to the sample, thereby reducing the overall distortion of the sample when using such a sample container to image the sample. Additionally, since the material of such a compliant cushion is limited to the thickness of the sheet of material, less overall material may be present, reducing distortion of the imaging energies (e.g., X-rays) used to image the sample by the compliant cushion (e.g., by absorption of the X-rays).

As shown, the sheet of material of such a compliant cushion could be formed to have a concave surface onto which a sample can be disposed. By providing this concave portion of the sheet of material with the middle of the portion in already in contact with an underlying floor of an enclosing rigid member of the sample container, the compliant cushion can provide support to the sample against gravity without significantly distorting the sample, thus improving the imaging of the sample. This benefit may be provided by the shape of the concave surface being similar to the rounded ‘natural’ shape of the sample and the concave portion of the sheet of material already being in contact with the supportive underlying rigid member, contact between the sheet of material and the rigid member prevents the sheet from being depressed further by the weight of the sample. Without such initial contact (or close proximity, e.g., less than 5 mm, or less than 1 mm) between the underside of the concave portion of the sheet of material and the floor of the rigid member, the weight of the sample might cause the sheet to deform and lower, causing the concave surface to become deeper and further from the ‘natural’ shape of the sample disposed therein, thus potentially deforming the sample.

The compliant cushion could be composed of a variety of materials configured in a variety of ways in order to provide support to a sample without significantly distorting the sample. For example, the flexible cushion could be composed of a foam (e.g., a sheet of foam material) composed of polyethylene. The compliant cushion could be composed of a material having a Young's modulus less than 10 kPa and/or could be formed to have an effective Young's modulus less than 10 kPa (e.g., by having a sheet thickness and material composition specified such that the cushion interacts with a sample disposed therein in a manner that effectuates such a low Young's modulus) in order to reduce distorting forces applied onto a sample while still providing support to the sample against distorting forces, e.g., forces exerted by gravity or by accelerations as the container is moved (e.g., to/from an imaging system, rotated or moved within an imaging system). For example, the compliant cushion could include a sheet of closed-foam polyethylene foam.

The material(s) of the compliant cushion and/or the rigid member could have a high transmissibility with respect to X-rays (e.g., the materials could transmit more than 98% of X-rays impinging thereon). For example, the compliant cushion and/or the rigid member could be composed of polymer materials that include no, or minimal amounts, of chlorine or fluorine and/or the compliant cushion and/or the rigid member could lack ‘high density’ polymer materials. For example, the rigid member could include polypropylene and the compliant cushion could include polyethylene (e.g., closed-cell polyethylene foam).

To improve the imaging of samples, a sample container (e.g., the sample container of FIGS. 1A-B) could be configured to prevent fluid from a sample disposed therein from being absorbed by materials of the sample container. Such absorption can result in the distortion of the sample from its pre-explantation state due to dehydration (as the fluid within the sample moves out of the sample to be absorbed by the sample container materials). Additionally, the absorption of such fluid into the material of the sample container can affect the imaging of the sample (e.g., due to increased attenuation of X-rays or other imaging materials by the fluid absorbed into the sample container materials) and/or analysis of the sample based on such imaging (e.g., due to the materials of the sample container becoming more difficult to distinguish from the volume of the sample, as the fluid-absorbed container material may appear similar to the sample in images thereof).

A sample container (e.g., a sample receptacle surface or other sample-contacting elements thereof) may be made impermeable to fluid from a sample, and thus prevent absorption of such tissue fluids into the sample container, in a variety of ways. For example, material of the sample container could be composed of a fluid-impermeable material. In examples wherein the material of the sample is a foam material, the foam could be a closed-cell foam, to prevent absorption of fluid into the cells of the foam. Additionally or alternatively, the material of the sample could include surface coatings, treatments, and/or features to repel fluid from the sample and/or to make the surface fluid-impermeable. For example, a coating of a hydrophobic or superhydrophobic material could be disposed on a sample-facing surface of the sample container (e.g., on the sample receptacle surface) and/or an array of posts or other textural features formed thereon to prevent wetting of the surface and/or migration of fluid from the sample through the surface into material of the sample container. For example, sample-adjacent materials of the sample container could be composed of an open-cell foam, but the foam could be composed of a hydrophobic material and/or have a hydrophobic coating disposed/formed thereon, preventing fluid from the sample from entering the open cells of the foam and thus being absorbed into the foam.

The geometry of the sample receptacle surface (e.g., 125) of a compliant cushion as described herein could be specified to provide support to samples placed thereon while reducing distortion of the geometry of such a sample. This could include the compliant cushion having a sample receptacle surface configured to receive samples that are less than a size of an imaging beam (e.g., an X-ray beam) of an imaging system, e.g., a width less than 110 mm and a height from the bottom-most area of the sample receptacle surface to a lid of the sample container less than 70 mm. The geometry of the sample receptacle surface of the compliant cushion could be specified to correspond to an expected geometry of sample to be disposed thereon. For example, for samples of explanted breast tissue or small tissue samples explanted from other organs/tissue, the sample receptacle surface could be a concave surface having a diameter between 2 and 3 cm and a depth (perpendicularly from the top of the concavity to the lowest area near the middle of the concave surface) of between 1.5 and 0.5 cm.

In some examples, the shape of the compliant cushion (e.g., the sample receptacle surface thereof) could be specified to correspond to a specific organ or tissue of interest. For example, the compliant cushion could have a concavity formed therein that corresponds to an outer surface of a kidney or other organ or tissue of interest, in order to provide support thereto in a manner that results in reduced distortion thereof. Such a complaint cushion could have a single ‘standard’ size for a specified organ or tissue, could come in a number of standard sizes, allowing the particular cushion and/or sample container to be selected for a particular organ/tissue, and/or could be formed for the organs/tissues of specific patients (e.g., based on anatomical scans of the patient's body, followed by formation of the cushion based on the scan data).

A sample container as described herein may include a lid. Such a lid could be removably couple-able to the remainder of the sample container (e.g., the rigid member 110 of a bottom 110a of the sample container) in order to prevent contaminants from affected a sample contained therein and/or to reduced evaporation of fluid therefrom. Such a lid could provide additional benefits. For example, the lid could, when coupled to the remainder of the sample container, enclose a volume in a watertight or other fluid-tight manner, thereby preventing messes (e.g., preventing fluid from a sample contained therein from spilling, preventing a stabilizing or preserving fluid added to the sample container from spilling). Such a lid could itself include one or more additional compliant cushions configured to provide support to samples contained in the sample container when the lid is fixed to the remainder of the container. For example, the lid 100b includes a second compliant cushion 130 disposed on a second rigid member 140 that is configured to be removably coupled to the first rigid member 110 of the bottom 110a. Such an additional compliant cushion 130 could be configured (e.g., by being formed from a sheet of material) to provide support to a sample while reducing distortion thereof. This could include providing non-deforming stabilizing forces onto a tissue sample to prevent it from moving as the sample container is moved (e.g., from near a patient to an imaging system, as it is rotated or otherwise moved while being imaged within such an imaging system, as the sample is moved from an imaging system to a pathology lab for further preparation, imaging, and/or analysis). A sample container as described herein could include additional compliant cushions (e.g., one or more cushions disposed on the wall of the rigid member 110 to stabilize a sample and/or to ensure the separation of the sample from the material of the walls of the rigid member 110).

As shown in FIGS. 1A-B, a sample container (e.g., rigid materials 110 and/or compliant cushions 120 thereof) may include labels disposed thereon/formed thereon/in to facilitate disposing a sample therein according to a pre-specified default orientation. This can be done to facilitate alignment of image data generated for samples contained in such sample containers with the anatomical alignment of the samples prior to explantation. Such alignment can assist surgeons, pathologists, or other healthcare workers in providing care to a patient by, e.g., allowing them to more easily correspond imaging data of the explanted sample with pre-surgical image data, imagery taken of the sample and/or surgical site during a surgical procedure, and/or personal recollections or notes about the sample and surrounding area during the surgical procedure. Thus, such labels (e.g., “superior,” “posterior,” “medial,” “lateral,” “inferior,” “anterior,” “caudal,” “cranial”) may be provided to unambiguously indicate the default alignment of the sample within the sample container, assisting a surgeon or other healthcare professional in placing an explanted sample within the sample container according to that default alignment. Such labels could be printed onto, formed in, adhered to, or otherwise disposed on or in material of the sample container (e.g., rigid materials, compliant cushions). Such labels could be disposed inside a partially enclosed volume of the sample container (e.g., as depicted in FIGS. 1A-B) and/or outside such a volume. Such labels could be implemented as a set of multiple labels (e.g., six labels, indicating six orthogonal anatomical directions) or in some other manner that is sufficient to indicate the default orientation. For example, a single arrow could be used to indicate a degenerate “up” orientation (which may be a superior, anterior, or other canonical anatomical orientation, or some other specified orientation), a single dot could be used to indicate a first direction (e.g., “medial”), with the shape of a cylindrical rigid material hull of the container indicating a second direction (e.g., “posterior”) such that a single default orientation is unambiguously indicated.

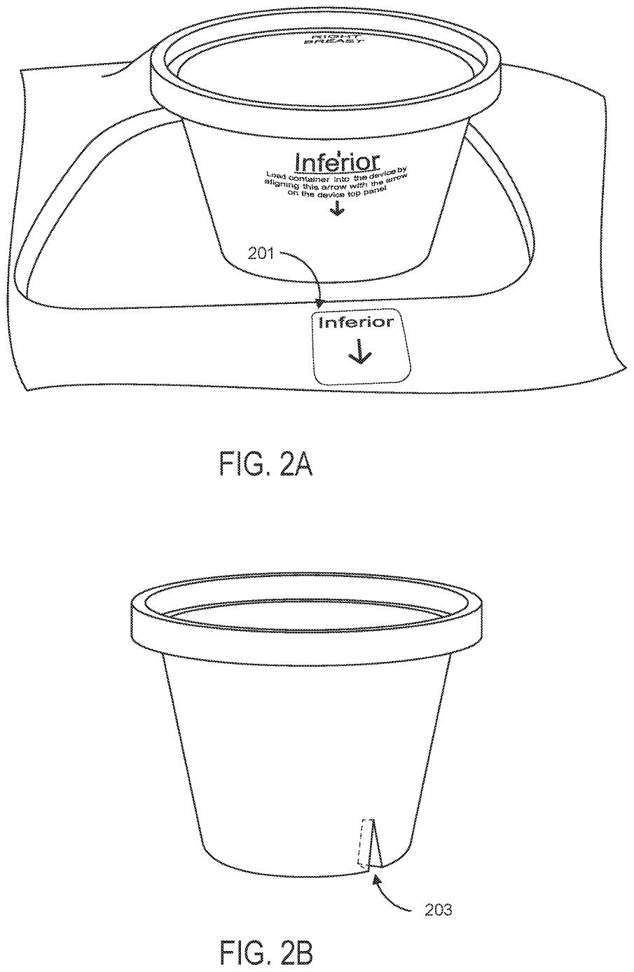

Such labels can facilitate a sample being placed into a sample container according to a default orientation. That default orientation can then be corresponded to imaging data generated for samples in the sample container. This could include ensuring that the sample container is, itself, placed into or on the imaging system according to a specified default orientation. For example, as shown in FIG. 2A, such an imaging system could include labels or other features to indicate to a healthcare professional an orientation of the sample container relative to the imaging system (e.g., the “Inferior” label with arrow 201, indicating that the “inferior” direction of the sample container should be aligned therewith). Additionally or alternatively, magnets, tabs or other formed features, or some other element(s) of the imaging system and/or sample container could be configured to exert aligning forces onto the sample container and/or to prevent the sample container to be emplaced on/in the imaging system in a non-aligned orientation. For example, as depicted in FIG. 2B, the sample container could include a concavity 203 or other formed feature that could correspond to a fin, ridge, or other corresponding formed feature of the imaging system, preventing the sample container from being fully seated onto the imaging system if the sample container is not in the correct alignment (i.e., with the fin or ridge of the imaging system disposed within the concavity of the sample container). In another example, the sample container could have a square or otherwise orientable shape that is configured to seat, in the specified orientation, into a corresponding formed feature of the imaging system.

Additionally or alternatively, the orientation of the sample container relative to the imaging system could be detected. This could include, e.g., using cameras or other light-sensitive elements to detect labels or other orientation-indicating features of the sample container. In another example, the sample container could include a magnet, RFID tag, or other feature that is detectable by a sensor (e.g., a magnetometer, an RFID reader) to detect the orientation of the sample container.

As noted above, either the imaging system and sample container could be configured to facilitate placement of the sample container on/within the imaging system according to a default orientation and/or the orientation of the sample container relative to the imaging system could be detectable (e.g., by using a camera to detect the orientation of the container). This knowledge of the orientation of the sample container relative to the imaging system, along with the assumption that the contents of the sample container have been deposited therein according to a default orientation, allow the sample imaging data to be displayed in a manner that is aligned to the ‘default orientation’ of the sample within the sample container. This can include providing an indication of that default orientation along with indication of the imaging data on a screen. For examples, a 3D or 2D indication of the sample could be provided along with an arrow, wind rose, or other visual feature to indicate “anterior,” “medial,” “superior” and/or other direction(s) of a patient's body relative to the indication of the sample according to the sample's orientation within the patient's body prior to explantation. Additionally or alternatively, 3D or 2D indications of the sample can be provided according to ‘standard’ orientations (e.g., through a coronal plane, through a sagittal plane, through an axial plane), with the correct orientation of the sample relative to the anatomy of the patient, prior to explantation, being determined from the detected and/or specified orientation of the sample container relative to the imaging system.

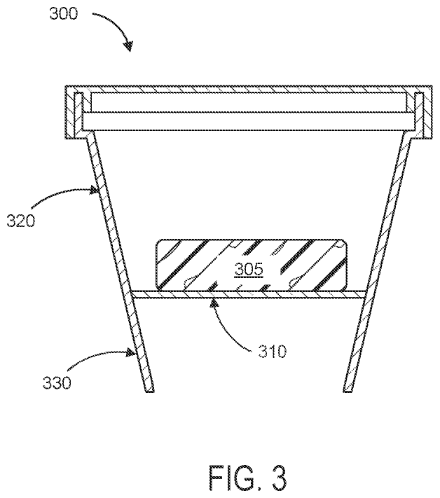

As noted above, compliant cushions or other elements of sample containers as described herein can be configured to place a sample disposed within the sample container within a preferred location and/or orientation relative to an imaging system, in order to improve imaging thereof. For example, for a micro-CT imager, there may be a region directly between an X-ray emitter and an X-ray detector which exhibits improved image resolution, contrast, or other imaging properties relative to more peripheral regions of a space, within the imaging system, that are capable of being imaged. For some imaging systems, samples, and/or sample containers, the distance between a sample and a floor, stage, or other element of the imaging system on which a sample container is disposed could be further extended by extending a rigid member of the sample container past a floor of that rigid member (on which a sample may be directly disposed, and/or above which the sample may be by one or more compliant cushions). FIG. 3 depicts a sample 305 disposed within such a sample container 300, which has a rigid member comprising a floor 310 (on which the sample 305 is directly disposed, but which may be separated therefrom by a compliant cushion) and an enclosing wall 320. The sample container 300 additionally includes an extension 330 which separates the floor 310 (and by extension, the sample 305) from a stage, floor, or other supporting surface of the imaging system. Such an extension may take the form of one or more separate legs or some other form (e.g., a roughly cylindrical extension of a roughly cylindrical wall 320 of the sample container 320). Such a sample container may be particularly beneficial for large, flat samples (e.g., sample 305), since such samples exhibit increased overall attenuation of X-rays or other imaging energies though their longest dimensions. For such samples, aligning the bulk of the sample with an X-ray emitter (or other imaging energy emitter source) can provide especial benefit, since more of the emitted imaging energy will have an opportunity to take a shorter path through the sample 305 (e.g., passing into the sample and then out of the top/bottom surfaces of the sample, before being imaged), increasing resolution and image contrast.

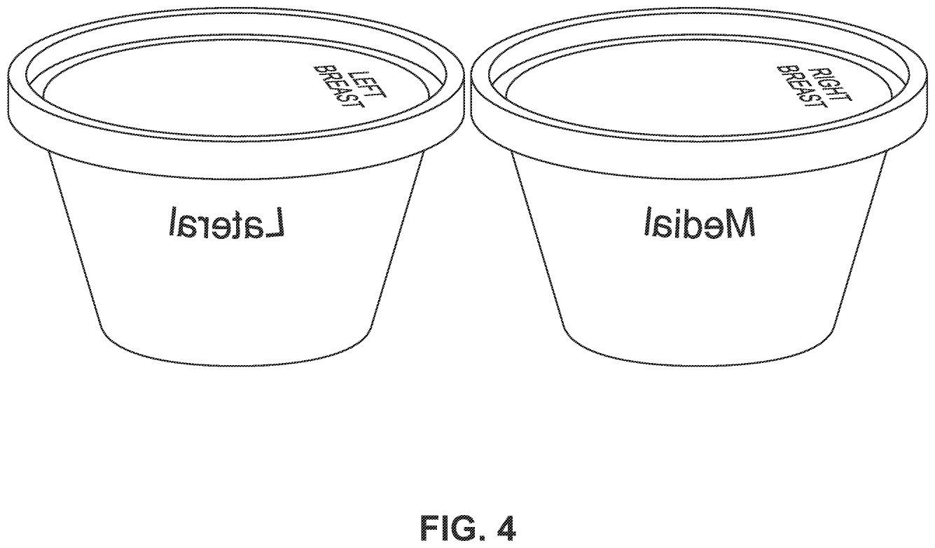

Since a sample container as described herein may include one or more labels to indicate the orientation of samples disposed therein, they may also come as sets or kits of such sample containers, with each container of a set labeled to correspond to a respective organ or tissue of an enumerated set of organs or tissues from which samples are to be taken. FIG. 4 shows an example of such a kit of sample containers, with one of the sample containers labeled for “left breast” tissue, and the other labeled for “right breast” tissue. In that particular example, the different target tissues/organs are from different sides of the body. Accordingly, the directional labeling of the containers is mirrored (e.g., e.g., the closer side of both containers of FIG. 4 being labeled alternatively with “medial” and “lateral”). This will be the case with any pair of containers from such a kit of containers that correspond to target organs/tissue from opposite sides of the midline of the body.

In many applications, it is desirable to fix or otherwise chemically prepare a tissue sample for slicing or other pathology analyses (e.g., staining, imaging), It can be beneficial for microscopic or other pathology images taken from tissue samples prepared in such a manner to be corresponded with other imaging data generated for such tissue samples while they were disposed within a sample container as described herein. For example, a pathological examination of the margin of a tissue sample could be beneficially corresponded to a particular location of the imaging data for the sample in order to determine where, within a patient and relative to the site of explantation of the tissue sample, to remove additional tissue in order to reduce the chance of remission. However, additional manipulation of the tissue sample subsequent to imaging in the sample container can distort the sample and/or change its orientation, making correspondence of the imaging data with the pathology data difficult. It would be beneficial to fix the sample (e.g., by introducing formalin or some other sample-preserving substance) which still in the sample container, to avoid distortion of the sample from its configuration during the imaging thereof. However, many sample-fixing or -preserving chemicals can be harsh, resulting in dissolution or other degradation of materials traditionally used for sample containers.

In order to address this shortcoming, a sample container as described herein could be made resistant to one or more specified sample-preserving substances (e.g., formalin). This could include forming the sample containers for materials that are intrinsically resistant to the sample-preserving substance(s) (e.g., polypropylene, polyethylene, a closed-cell foam of polyethylene). Additionally or alternatively, the sample container could include surface coatings or treatments to prevent underlying materials of the sample container from being degraded by the sample-preserving substance(s). This could include adding coatings of materials that are resistant to the sample-preserving substance(s) and/or coatings of materials that are repellant to a solvent of the sample-preserving substance(s) (e.g., a hydrophobic or superhydrophobic coating or surface treatment, an oleophobic or superoleophobic coating or surface treatment). Note that the sample container being made resistant to one or more specified sample-preserving substances does not require the container being made impervious to the one or more specified sample-preserving substances. For example, the sample container could merely be made sufficiently resistant to the one or more specified sample-preserving substances that the sample container does not collapse, form holes, or otherwise exhibit some super-threshold damage prior to a specified duration of exposure to the one or more specified sample-preserving substances that is sufficient to fix or otherwise prepare the sample contained therein prior to removal therefrom (e.g., a duration that is sufficient to partially fix a sample such that it may be removed, with no or significantly reduced distortion, from the sample container into another container to complete the fixation thereof).

### III. Example Systems

Computational and/or imaging functions described herein may be performed by one or more computing and/or imaging systems. Such functions may include functions to operate an imager to generate scan data for a target sample contained in a sample container as described herein, functions to reconstruct volumetric density information from such scan data, functions to render cross-sectional, perspective, numerically projected, or other two-dimensional views from the volumetric density data, functions to register or otherwise align such three-dimensional density data (or two-dimensional projections thereof) to two- or three-dimensional image data generated by some other system (e.g., by a mammographic imaging system), and/or user interface functions. Such a computing system may be integrated into or take the form of a computing device, such as a portable medical imaging system, a remote interface for such an imaging system, a pathologist's workstation, a tissue analysis and/or sectioning table or workstation, a tablet computer, a laptop computer, a server, a cloud computing network, and/or a programmable logic controller.

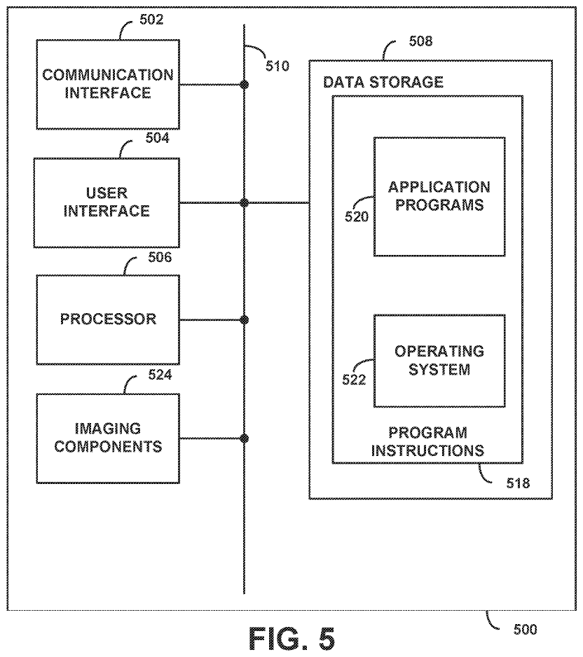

For purposes of example, FIG. 5 is a simplified block diagram showing some of the components of an example computing device 500 that may include components for providing indications of scan-related data onto screen or other display device. Alternatively, an example computing device may lack such components and provide indications of imaging data via some other means (e.g., via the internet or some other network or other communications interface).

The computing device 500 may also include imaging components 524 for obtaining imaging data for such a tissue sample. Imaging components 524 may include a micro-CT imager, an MRI imager, and/or some other components configured to provide information indicative of volumetric density information or other types of 3D image data (e.g., 3D tensors indicative of the pattern of diffusion throughout an organ) for a sample. Alternatively, an example computing device may lack such components and receive scan information via some other means (e.g., via the internet or some other network or other communications interface).

Such imaging components 524 may include visible-light cameras or other light sensing elements to allow the imaging components 524 to detect the orientation, relative to the imaging components 524, of a sample container based on label(s) or other features thereof. This can then allow the pre-removal anatomical orientation of the sample within the sample container to be determined, allowing the imaging data generated for the sample to be displayed in a manner aligned with that pre-removal anatomical orientation (e.g., aligning the display of imaging data for explanted breast tissue with the medio-lateral, antero-posterior, and dorso-ventral axes of the patient's body according to the explanted breast tissue's orientation prior to removal from the patient's body). The imaging components 524 could additionally or alternatively include visible markings (e.g., labels, formed features) indicative of a desired orientation of the sample container, informing a healthcare technician how to place the sample container relative to the imaging components 524 (e.g., on an imaging stage thereof) so that the system 500 can display imaging data generated for the sample in a manner aligned with the pre-removal anatomical orientation of the sample. The imaging components 524 and/or sample container could additionally or alternatively include ridges, magnets, shaped components, or other formed features to align the sample container with the imaging components 524 and/or to prevent the sample container from being placed on/in the imaging components 524 in a misaligned manner, so that the system 500 can display imaging data generated for the sample in a manner aligned with the pre-removal anatomical orientation of the sample.

As shown in FIG. 5, computing device 500 may include a communication interface 502, a user interface 504, a processor 506, data storage 508, and imaging components 524, all of which may be communicatively linked together by a system bus, network, or other connection mechanism 510.

Communication interface 502 may function to allow computing device 500 to communicate, using analog or digital modulation of electric, magnetic, electromagnetic, optical, or other signals, with other devices, access networks, and/or transport networks. Thus, communication interface 502 may facilitate circuit-switched and/or packet-switched communication, such as plain old telephone service (POTS) communication and/or Internet protocol (IP) or other packetized communication. For instance, communication interface 502 may include a chipset and antenna arranged for wireless communication with a radio access network or an access point. Also, communication interface 502 may take the form of or include a wireline interface, such as an Ethernet, Universal Serial Bus (USB), or High-Definition Multimedia Interface (HDMI) port. Communication interface 502 may also take the form of or include a wireless interface, such as a Wi-Fi, BLUETOOTH®, global positioning system (GPS), or wide-area wireless interface (e.g., WiMAX or 3GPP Long-Term Evolution (LTE)), However, other forms of physical layer interfaces and other types of standard or proprietary communication protocols may be used over communication interface 502. Furthermore, communication interface 502 may comprise multiple physical communication interfaces (e.g., a Wi-Fi interface, a BLUETOOTH® interface, and a wide-area wireless interface).

In some embodiments, communication interface 502 may function to allow computing device 500 to communicate, with other devices, remote servers, access networks, and/or transport networks. For example, the communication interface 502 may function to transmit and/or receive an indication of image information, to transmit an indication of imaging-related data that can then be displayed, to transmit an indication of a relative orientation and/or translation of 3D image data relative to target 2D and/or 3D image data, or some other information. For example, the computing device 500 could be a pathologist's workstation located in a pathologist's office, remote from one or more operating rooms wherein sample explantation and imaging occur, and the remote system could be a display or other system configured to display the results of analyses as described herein to facilitate the diagnosis and treatment of disease by surgeons in the operating room(s).

In some examples, the computing device 500 could include a volumetric imaging system (e.g., a micro-CT imager) and computational resources for reconstructing volumetric density information or other types of 3D images from scan data, for identifying regions of interest from the volumetric density information, for registering the 3D images to target 2D and/or 3D images (e.g., 2D mammogram images), for rendering images of tissue samples based on the volumetric density information (e.g., perspective views, simulated two-dimensional slices through the sample, numerically-generated simulated 2D images through the sample as projected onto a specified 2D plane, etc.), or for performing some other computational tasks. Such computational resources could include one or more GPUs or other processors specialized for reconstruction, rendering, or other image-processing tasks as described herein.

Such a computing device 500 could be in communication with a terminal device (e.g., a workstation, a tablet computer, a head-mounted display, an automated sectioning tool, a thin client) and could provide rendered images to such a terminal in response to user inputs indicative of such rendered images. For example, a user input to a user interface (e.g., keyboard, touchscreen, mouse, head tracker of a head-mounted display) could cause the terminal device to send, to the computing device 500, a request for imaging data related to the user input (e.g., a request for an updated two-dimensional numerical projection of the 3D density information image based on a user input updating the registered relative orientation and/or location of the 3D density information relative to a target 2D or 3D image). The computing device 500 could then, in response to the request, transmit to the terminal device some information indicative of the requested data (e.g., one or more two-dimensional images, a wireframe/segmentation map or other simplified representation of the volumetric density information or other 3D image data). Such operations could allow the terminal device to be lower cost, lighter, smaller, or otherwise improved to facilitate interaction therewith by a pathologist or other healthcare professional while maintaining access to the imaging and processing resources of the computing device 500.

User interface 504 may function to allow computing device 500 to interact with a user, for example to receive input from and/or to provide output to the user. Thus, user interface 504 may include input components such as a keypad, keyboard, touch-sensitive or presence-sensitive panel, computer mouse, trackball, joystick, microphone, and so on. User interface 504 may also include one or more output components such as a display screen which, for example, may be combined with a presence-sensitive panel. The display screen may be based on CRT, LCD, and/or LED technologies, or other technologies now known or later developed. User interface 504 may also be configured to generate audible output(s), via a speaker, speaker jack, audio output port, audio output device, earphones, and/or other similar devices.

In some embodiments, user interface 504 may include a display that serves to provide, indications of 2D and/or 3D images, potentially overlaid on each other (e.g., a numerically-generated 2D projection of a 3D image that has been aligned to a target 2D image), regions of interest within such images, or other imaging-related information to a user. Additionally, user interface 504 may include one or more buttons, switches, knobs, and/or dials that facilitate the configuration and operation of the imaging components 524 or to configure some other operation of the computing device 500. It may be possible that some or all of these buttons, switches, knobs, and/or dials are implemented as functions on a touch- or presence-sensitive panel.

Processor 506 may comprise one or more general purpose processors—e.g., microprocessors—and/or one or more special purpose processors—e.g., digital signal processors (DSPs), graphics processing units (GPUs), floating point units (FPUs), network processors, or application-specific integrated circuits (ASICs). In some instances, special purpose processors may be capable of image processing, image registration and/or scaling, tomographic reconstruction, numerical simulation of 2D projection images from 3D image data, among other applications or functions. Data storage 508 may include one or more volatile and/or non-volatile storage components, such as magnetic, optical, flash, or organic storage, and may be integrated in whole or in part with processor 506. Data storage 508 may include removable and/or non-removable components.

Processor 506 may be capable of executing program instructions 518 (e.g., compiled or non-compiled program logic and/or machine code) stored in data storage 508 to carry out the various functions described herein. Therefore, data storage 508 may include a non-transitory computer-readable medium, having stored thereon program instructions that, upon execution by computing device 500, cause computing device 500 to carry out any of the methods, processes, or functions disclosed in this specification and/or the accompanying drawings.

By way of example, program instructions 518 may include an operating system 522 (e.g., an operating system kernel, device driver(s), and/or other modules) and one or more application programs 520 (e.g., sample scanning functions, reconstruction or rendering functions) installed on computing device 500.

Application programs 520 may take the form of “apps” that could be downloadable to computing device 500 through one or more online application stores or application markets (via, e.g., the communication interface 502). However, application programs can also be installed on computing device 500 in other ways, such as via a web browser or through a physical interface (e.g., a USB port) of the computing device 500.

In some examples, portions of the methods described herein could be performed by different devices, according to an application. For example, different devices of a system could have different amounts of computational resources (e.g., memory, processor cycles) and different information bandwidths for communication between the devices. For example, a first device could be a pathologist's workstation or remote interface that could transmit commands and/or requests for imaging data to another device or server that has the necessary computational resources to perform the reconstruction and/or rendering methods required to generate the requested imaging data, e.g., from CT scan data of a tissue sample. Different portions of the methods described herein could be apportioned according to such considerations.

### IV. Example Methods

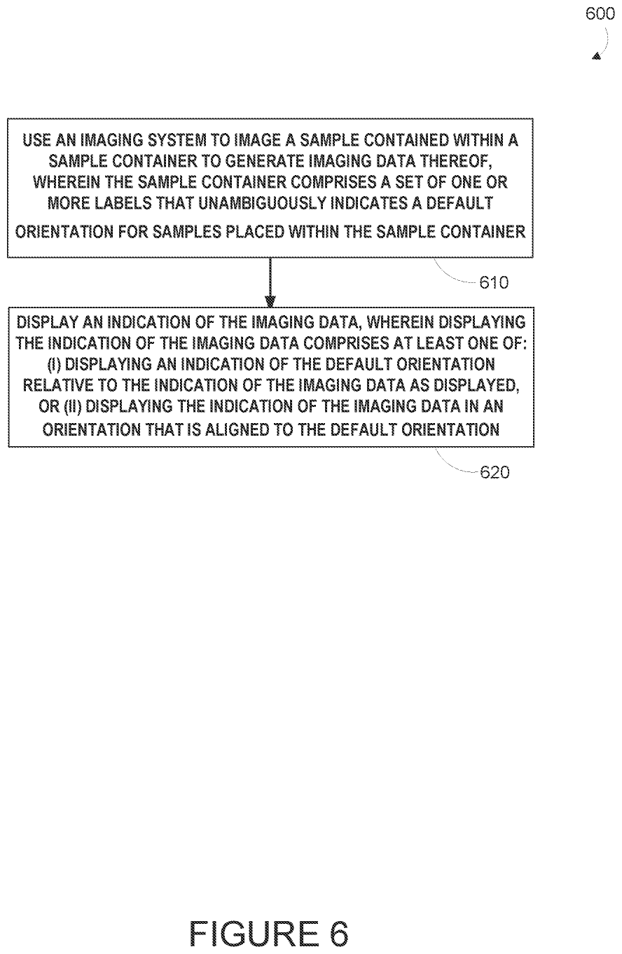

FIG. 6 is a flowchart of a method 600. The method 600 includes using an imaging system to image a sample contained within a sample container to generate imaging data thereof, wherein the sample container comprises a set of one or more labels that unambiguously indicates a default orientation for samples placed within the sample container (610). The method 600 additionally includes displaying an indication of the imaging data, wherein displaying the indication of the imaging data comprises at least one of: (i) displaying an indication of the default orientation relative to the indication of the imaging data as displayed, or (ii) displaying the indication of the imaging data in an orientation that is aligned to the default orientation (620). The method 600 could include additional elements or features.

In any of the methods described herein (e.g., method 600, or other embodiments described herein), the process of obtaining (e.g., “receiving”) imaging data (e.g., volumetric density information or other 2D and/or 3D image information) about a target sample and/or region of a body could include a variety of different processes and/or apparatus. In some examples, the image information could be stored on a hard drive that is accessed to and used according to the embodiments described herein. Such stored image information could be generated near in time and/or space to its use to facilitate guidance of surgical procedures (e.g., explantation of samples of tissue in order to, e.g., remove a tumor or other target) or could be generated a longer period of time before and/or distance away from the time and place at which the information is used to facilitate diagnosis of a condition, planning or provision of a treatment (e.g., a follow-up tissue removal surgery), or some other end. For example, the image data could be generated by operating an X-ray scanner or other volumetric imaging device that is located in an operating room where the tissue sample is removed from a patient. Such volumetric density information could be used by a surgeon and/or radiologist to decide, during the tissue removal procedure, whether additional tissue should be removed from the patient and, if so, from what location(s) within the patient's body.

### V. Conclusion

The above detailed description describes various features and functions of the disclosed systems, devices, and methods with reference to the accompanying figures. In the figures, similar symbols typically identify similar components, unless context indicates otherwise. The illustrative embodiments described in the detailed description, figures, and claims are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The embodiments herein are described as being used by pathologists, radiologists, surgeons, and other healthcare professionals to facilitate storage, imaging, fixation, or other manipulation or analysis of tissue samples. However, these are merely illustrative example applications. The embodiments described herein could be employed to store, image, preserve, or otherwise manipulate other objects or substances of interest (e.g., plant or animal tissue).

With respect to any or all of the message flow diagrams, scenarios, and flowcharts in the figures and as discussed herein, each step, block and/or communication may represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages may be executed out of order from that shown or discussed, including in substantially concurrent or in reverse order, depending on the functionality involved. Further, more or fewer steps, blocks and/or functions may be used with any of the message flow diagrams, scenarios, and flow charts discussed herein, and these message flow diagrams, scenarios, and flow charts may be combined with one another, in part or in whole.

A step or block that represents a processing of information may correspond to circuitry that can be configured to perform the specific logical functions of a herein-described method or technique. Alternatively or additionally, a step or block that represents a processing of information may correspond to a module, a segment, or a portion of program code (including related data). The program code may include one or more instructions executable by a processor for implementing specific logical functions or actions in the method or technique. The program code and/or related data may be stored on any type of computer-readable medium, such as a storage device, including a disk drive, a hard drive, or other storage media.

The computer-readable medium may also include non-transitory computer-readable media such as computer-readable media that stores data for short periods of time like register memory, processor cache, and/or random access memory (RAM). The computer-readable media may also include non-transitory computer-readable media that stores program code and/or data for longer periods of time, such as secondary or persistent long term storage, like read only memory (ROM), optical or magnetic disks, and/or compact-disc read only memory (CD-ROM), for example. The computer-readable media may also be any other volatile or non-volatile storage systems. A computer-readable medium may be considered a computer-readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

### VI. Enumerated Example Embodiments

Embodiments of the present disclosure may thus relate to one of the enumerated example embodiments (EEEs) listed below. It will be appreciated that features indicated with respect to one EEE can be combined with other EEEs.

EEE 1 is a sample container including: (i) a rigid member that at least partially encloses a first volume; and (ii) a compliant cushion disposed within the first volume, wherein the compliant cushion comprises a sheet of material formed to at least partially enclose a portion of the first volume and to define a sample receptacle surface, wherein the sheet of material is shaped such that a sample can be placed on the sample receptacle surface and be thereby separated from the rigid member by the sheet of material.

EEE 2 is the sample container of EEE 1, further comprising: (i) a lid configured to removably couple to the rigid member, thereby fully enclosing the first volume; and (ii) an additional compliant cushion, wherein the additional compliant cushion is shaped such that, when a sample is placed on the sample receptacle surface, the additional compliant cushion is in contact with the sample and stabilizes the sample within the sample container.

EEE 3 is the sample container of EEE 2, wherein the lid and rigid member, when the lid is removably coupled to the rigid member, prevent fluids from escaping from the first volume.

EEE 4 is the sample container of any of EEEs 1-3, further comprising a set of one or more labels disposed on at least one of the rigid member or the compliant cushion, wherein the set of one or more labels unambiguously indicates a default orientation for samples placed on the sample receptacle surface.

EE 5 is the sample container of EEE 4, wherein the sheet of material is impermeable to fluid from the sample.

EEE 6 is the sample container of any of EEEs 4-5, wherein the rigid member includes an alignment feature to align the sample container with a corresponding alignment feature of an imaging apparatus.

EEE 7 is the sample container of any of EEEs 1-3, wherein the sheet of material is impermeable to fluid from the sample.

EEE 8 is the sample container of any of EEEs 1-7, wherein the sample container is formed such that, when the sample container is placed within an imaging system, the sample receptacle surface is located within a region of increased sensitivity of the imaging system.

EEE 9 is the sample container of EEE 8, wherein the rigid member comprises a floor and one or more side walls that at least partially enclose the first volume, and wherein the rigid member additionally comprises an extension that extends below the floor, thereby elevating the sample receptacle surface to be located within the region of increased sensitivity of the imaging system when the sample container is placed within the imaging system.

EEE 10 is the sample container of any of EEEs 1-9, wherein the sample receptacle surface has a shape that corresponds to a shape of a specific target organ.

EEE 11 is the sample container of any of EEEs 1-10, wherein the rigid member and sheet of material are resistant to a specified sample-preserving substance.

EEE 12 is the sample container of EEE 11, wherein the sheet of material comprises polyethylene.

EEE 13 is the sample container of any of EEEs 1-12, wherein the sample receptacle surface is concave.

EEE 14 is the sample container of EEE 13, wherein a middle portion of a portion of the sheet of material that forms the concave sample receptacle surface is within 1 millimeter of a floor of the rigid member.

EEE 15 is the sample container of EEE 14, wherein the sheet of material comprises closed-cell polyethylene foam.

EEE 16 is a sample container including: (i) a rigid member that at least partially encloses a first volume; (ii) a compliant cushion disposed within the first volume, wherein the compliant cushion defines a sample receptacle surface, wherein the compliant cushion is shaped such that a sample can be placed on the sample receptacle surface and be thereby separated from the rigid member by the compliant cushion; and (iii) a set of one or more labels disposed on at least one of the rigid member or the compliant cushion, wherein the set of one or more labels unambiguously indicates a default orientation for samples placed on the sample receptacle surface.

EEE 17 is the sample container of EEE 16, further comprising: (i) a lid configured to removably couple to the rigid member, thereby fully enclosing the first volume; and (ii) an additional compliant cushion, wherein the additional compliant cushion is shaped such that, when a sample is placed on the sample receptacle surface, the additional compliant cushion is in contact with the sample and stabilizes the sample within the sample container.

EEE 18 is the sample container of EEE 17, wherein the lid and rigid member, when the lid is removably coupled to the rigid member, prevent fluids from escaping from the first volume.

EEE 19 is the sample container of any of EEEs 16-18, wherein the compliant cushion is impermeable to fluid from the sample.

EEE 20 is the sample container of any of EEEs 16-19, wherein the rigid member includes an alignment feature to align the sample container with a corresponding alignment feature of an imaging apparatus.

EEE 21 is the sample container of any of EEEs 16-20, wherein the sample container is formed such that, when the sample container is placed within an imaging system, the sample receptacle surface is located within a region of increased sensitivity of the imaging system.

EEE 22 is the sample container of EEE 21, wherein the rigid member comprises a floor and one or more side walls that at least partially enclose the first volume, and wherein the rigid member additionally comprises an extension that extends below the floor, thereby elevating the sample receptacle surface to be located within the region of increased sensitivity of the imaging system when the sample container is placed within the imaging system.

EEE 23 is the sample container of any of EEEs 16-22, wherein the sample receptacle surface has a shape that corresponds to a shape of a specific target organ.

EEE 24 is the sample container of any of EEEs 16-23, wherein the rigid member and compliant cushion are resistant to a specified sample-preserving substance.

EEE 25 is the sample container of EEE 24, wherein the compliant cushion comprises polyethylene.

EEE 26 is a sample container including: (i) a rigid member that at least partially encloses a first volume; and (ii) a compliant cushion disposed within the first volume, wherein the compliant cushion defines a sample receptacle surface, wherein the compliant cushion is shaped such that a sample can be placed on the sample receptacle surface and be thereby separated from the rigid member by the compliant cushion, and wherein the sample receptacle surface of the compliant cushion is impermeable to fluid from the sample.

EEE 27 is the sample container of EEE 26, further comprising: (i) a lid configured to removably couple to the rigid member, thereby fully enclosing the first volume; and (ii) an additional compliant cushion, wherein the additional compliant cushion is shaped such that, when a sample is placed on the sample receptacle surface, the additional compliant cushion is in contact with the sample and stabilizes the sample within the sample container.

EEE 28 is the sample container of EEE 27, wherein the lid and rigid member, when the lid is removably coupled to the rigid member, prevent fluids from escaping from the first volume.

EEE 29 is the sample container of any of EEEs 26-29, wherein the sample container is formed such that, when the sample container is placed within an imaging system, the sample receptacle surface is located within a region of increased sensitivity of the imaging system.

EEE 30 is the sample container of EEE 29, wherein the rigid member comprises a floor and one or more side walls that at least partially enclose the first volume, and wherein the rigid member additionally comprises an extension that extends below the floor, thereby elevating the sample receptacle surface to be located within the region of increased sensitivity of the imaging system when the sample container is placed within the imaging system.

EEE 31 is the sample container of any of EEEs 26-30, wherein the sample receptacle surface has a shape that corresponds to a shape of a specific target organ.

EEE 32 is the sample container of any of EEEs 26-31, wherein the rigid member and compliant cushion are resistant to a specified sample-preserving substance.

EEE 33 is the sample container of EEE 32, wherein the compliant cushion comprises polyethylene.

EEE 34 is a kit of two or more sample containers, wherein each sample container comprises a respective label indicative of a respective organ or tissue from an enumerated set of two or more organs or tissues.

EEE 35 is the kit of EEE 34, wherein a first sample container of the kit has a label indicative of a left breast, and wherein a second sample container of the kit has a label indicative of a right breast.

EEE 36 is the kit of any of EEEs 34-35, wherein first and second sample containers of the kit include respective sets of one or more labels that unambiguously indicate respective default orientations for respective first and second samples placed within the first and second sample containers, respectively, wherein the first sample container of the kit has an additional label indicative of tissue from the right side of the body, and wherein the second sample container of the kit has an additional label indicative of tissue from the left side of the body such that the set of one or more label of the first sample container mirror the set of one or more labels of the second sample container.

EEE 37 is a method including: (i) using an imaging system to image a sample contained within a sample container to generate imaging data thereof, wherein the sample container comprises a set of one or more labels that unambiguously indicates a default orientation for samples placed within the sample container; and (ii) displaying an indication of the imaging data, wherein displaying the indication of the imaging data comprises at least one of: (i) displaying an indication of the default orientation relative to the indication of the imaging data as displayed, or (ii) displaying the indication of the imaging data in an orientation that is aligned to the default orientation.

EEE 28 is the method of EEE 37, wherein the imaging system comprises an indication thereon of a default orientation of the sample container relative to the imaging system, and wherein displaying the indication of the imaging data is performed based on an assumption that the sample container has been placed on or within the imaging system according to the indicated default orientation relative to the imaging system.

EEE 39 is the method of EEE 37, further comprising: operating a camera of the imaging system to detect an orientation of the sample container relative to the imaging system, wherein displaying the indication of the imaging data is performed based on the detected orientation of the sample container.

EEE 40 is a non-transitory computer-readable medium, configured to store at least computer-readable instructions that, when executed by one or more processors of a computing device, causes the computing device to perform controller operations to perform the method of any preceding EEE.

EEE 41 is a system including: (i) a controller comprising one or more processors; and (ii) a non-transitory readable medium having stored therein computer-readable instructions that, when executed by the one or more processors of the controller, cause the system to perform the method of any of EEEs 37-39.

1. A sample container comprising:
a rigid member that at least partially encloses a first volume; and
a compliant cushion disposed within the first volume, wherein the compliant cushion comprises a sheet of material formed to at least partially enclose a portion of the first volume and to define a sample receptacle surface, wherein the sheet of material is shaped such that a sample can be placed on the sample receptacle surface and be thereby separated from the rigid member by the sheet of material.

2-3. (canceled)

4. The sample container of claim 1, further comprising a set of one or more labels disposed on at least one of the rigid member or the compliant cushion, wherein the set of one or more labels unambiguously indicates a default orientation for samples placed on the sample receptacle surface.

5. The sample container of claim 4, wherein the sheet of material is impermeable to fluid from the sample.

6. The sample container of claim 4, wherein the rigid member includes an alignment feature to align the sample container with a corresponding alignment feature of an imaging apparatus.

7. (canceled)

8. The sample container claim 1, wherein the sample container is formed such that, when the sample container is placed within an imaging system, the sample receptacle surface is located within a region of increased sensitivity of the imaging system.

9-12. (canceled)

13. The sample container of claim 1, wherein the sample receptacle surface is concave, and wherein a middle portion of a portion of the sheet of material that forms the concave sample receptacle surface is within 1 millimeter of a floor of the rigid member.

14. (canceled)

15. The sample container of claim 13, wherein the sheet of material comprises closed-cell polyethylene foam.

16. A sample container comprising:
a rigid member that at least partially encloses a first volume;
a compliant cushion disposed within the first volume, wherein the compliant cushion defines a sample receptacle surface, wherein the compliant cushion is shaped such that a sample can be placed on the sample receptacle surface and be thereby separated from the rigid member by the compliant cushion; and
a set of one or more labels disposed on at least one of the rigid member or the compliant cushion, wherein the set of one or more labels unambiguously indicates a default orientation for samples placed on the sample receptacle surface.

17. The sample container of claim 16, further comprising:
a lid configured to removably couple to the rigid member, thereby fully enclosing the first volume; and
an additional compliant cushion, wherein the additional compliant cushion is shaped such that, when a sample is placed on the sample receptacle surface, the additional compliant cushion is in contact with the sample and stabilizes the sample within the sample container.

18. The sample container of claim 17, wherein the lid and rigid member, when the lid is removably coupled to the rigid member, prevent fluids from escaping from the first volume.

19. The sample container of claim 16, wherein the compliant cushion is impermeable to fluid from the sample.

20. The sample container of claim 16, wherein the rigid member includes an alignment feature to align the sample container with a corresponding alignment feature of an imaging apparatus.

21. The sample container of claim 16, wherein the sample container is formed such that, when the sample container is placed within an imaging system, the sample receptacle surface is located within a region of increased sensitivity of the imaging system.

22. The sample container of claim 21, wherein the rigid member comprises a floor and one or more side walls that at least partially enclose the first volume, and wherein the rigid member additionally comprises an extension that extends below the floor, thereby elevating the sample receptacle surface to be located within the region of increased sensitivity of the imaging system when the sample container is placed within the imaging system.

23. The sample container of claim 16, wherein the sample receptacle surface has a shape that corresponds to a shape of a specific target organ.

24. The sample container of claim 16, wherein the rigid member and compliant cushion are resistant to a specified sample-preserving substance.

25. The sample container of claim 24, wherein the compliant cushion comprises polyethylene.

26-36. (canceled)

37. A non-transitory computer-readable medium, configured to store at least computer-readable instructions that, when executed by one or more processors of a computing device, causes the computing device to perform controller operations comprising:
using an imaging system to image a sample contained within a sample container to generate imaging data thereof, wherein the sample container comprises a set of one or more labels that unambiguously indicates a default orientation for samples placed within the sample container; and
displaying an indication of the imaging data, wherein displaying the indication of the imaging data comprises at least one of: (i) displaying an indication of the default orientation relative to the indication of the imaging data as displayed, or (ii) displaying the indication of the imaging data in an orientation that is aligned to the default orientation.

38. The non-transitory computer-readable medium of claim 37, wherein the imaging system comprises an indication thereon of a default orientation of the sample container relative to the imaging system, and wherein displaying the indication of the imaging data is performed based on an assumption that the sample container has been placed on or within the imaging system according to the indicated default orientation relative to the imaging system.

39. The non-transitory computer-readable medium of claim 37, further comprising:
operating a camera of the imaging system to detect an orientation of the sample container relative to the imaging system, wherein displaying the indication of the imaging data is performed based on the detected orientation of the sample container.

40-41. (canceled)
